(19) United States
(12) Patent Application Publication
(10) Pub. No.: US 2013/0326613 A1
(43) Pub. Date: Dec. 5, 2013

(54) DYNAMIC CONTROL OF DEVICE UNLOCKING SECURITY LEVEL

(71) Applicant: Gregory Peter Kochanski, Pittsburgh, PA (US)

(72) Inventor: Gregory Peter Kochanski, Pittsburgh, PA (US)

(21) Appl. No.: 13/485,130

(22) Filed: May 31, 2012

(51) Int. Cl. G06F 21/00

(52) U.S. Cl. 726/19; 726/16

(57) ABSTRACT

Secure access of an electronic device may be dynamically controlled based on an adaptive algorithm. Secure access may comprise locking or unlocking of the electronic device. The adaptive algorithm may enable adjusting parameters used in determining when access to the electronic device is granted or denied. The parameters may comprise one or more thresholds used when comparing current user related information, such as biometric information, with corresponding prior information. The adaptive algorithm may enable adjusting the parameters based on valuation of information that may be exposed when the electronic device is accessed, probability of unwanted access, and/or acceptable cost of improper denial of access.

### FIELD

Certain embodiments of the disclosure relate to communications. More specifically, certain embodiments of the disclosure relate to dynamic control of device unlocking security level.

### BACKGROUND

Various types of electronic devices are now commonly utilized. In this regard, electronic devices may include, for example, personal and non-personal devices, mobile and non-mobile devices, communication (wired and/or wireless) devices, general purpose and special purpose devices. Examples of electronic devices may comprise personal computers, laptops, cellular phones, smartphones, tablets and the like. In many instances, electronic devices may be utilized by one or more users, for various purposes, both business and personal. In this regard, many users utilize electronic devices for many purposes which may entail providing and/or using confidential and/or personal information. For example, users may use their smartphones and/or tablets for shopping, planning and/or scheduling personal and/or professional appointments, conducting financial transactions (e.g., banking), and/or conducting business or other professional interactions (e.g., emails). As a result, electronic devices may contain significant amounts of confidential and valuable information. Therefore, guarding against unwanted access to electronic devices is becoming more and more important.

Further limitations and disadvantages of conventional and traditional approaches will become apparent to one of skill in the art, through comparison of such systems with some aspects of the present disclosure as set forth in the remainder of the present application with reference to the drawings.

### BRIEF SUMMARY

A system and/or method is provided for dynamic control of a device unlocking security level, substantially as shown in and/or described in connection with at least one of the figures, as set forth more completely in the claims.

These and other advantages, aspects and novel features of the present disclosure, as well as details of an illustrated embodiment thereof, will be more fully understood from the following description and drawings.

### BRIEF DESCRIPTION OF SEVERAL VIEWS OF THE DRAWINGS

FIG. 1 is a block diagram illustrating a communication device that may be locked and/or unlocked based on user related data, in accordance with an embodiment of the disclosure.

FIG. 2 is a block diagram illustrating use of dynamic facial recognition based secure access function, in accordance with an embodiment of the disclosure.

FIG. 3 a block diagram illustrating an electronic device that supports dynamic control of secure access functions, in accordance with an embodiment of the disclosure.

FIG. 4 is a flow chart that illustrates steps for dynamically controlled secure access, in accordance with an embodiment of the disclosure.

### DETAILED DESCRIPTION

Certain embodiments of the disclosure may be found in a method and system for dynamic control of device unlocking security level. In various embodiments of the disclosure, security access functions in an electronic device may be dynamically controlled, modifying outcome of the security access functions—i.e. whether to grant or deny access based on these functions—based on adaptive adjustment of parameters controlling these functions and/or operations relating to (or part of) these security access functions. The security access functions may enable or disable access to the electronic device, access to particular application(s) and/or function(s) in the electronic device, access to data available in and/or via the electronic device, and/or locking or unlocking of the electronic device. The security access functions may comprise use of information relating to a user of the electronic device. In this regard, the dynamic control of the security access function may comprise adaptively adjusting one or more access related parameters utilized in determining when access to the electronic device is allowed or denied, based on comparing the user related information with corresponding previous information. Determining when to adjust security level in the electronic device may also be based on, for example, monitoring and/or tracking of the electronic device, its location and/or environment, its operations, applications and/or programs running or executed therein, and/or interactions between the electronic device and user(s) thereof. In this regard, determining the required security level in the electronic device, and controlling the secure access functions based thereon may be performed based on an evaluation of a likelihood of unauthorized access, a cost of unauthorized access to the electronic device, and/or a cost (or inconvenience) of improper rejection of access—i.e., denying access to an intended user. Accordingly, the access related parameters may comprise parameters or thresholds that are used in determining when variations between the user related information with corresponding previous information are acceptable (i.e., variation tolerance thresholds) and/or thresholds that are used in determining when/if to adjust security level of the electronic device (e.g., thresholds relating to cost or valuation analysis). The electronic device may collect and/or maintain at least some of the corresponding previous information, and/or may enable access to such information when the information may not be stored directly in the electronic device—e.g., when the information is stored or maintained external to the electronic device, such as in a dedicated physical or logical storage system, and is retrievable by the electronic device (e.g., via Internet) when needed.

The one or more access related parameters may comprise a plurality of thresholds for controlling acceptable data variation when determining based on data comparison whether to grant access (or not) to the electronic device, to particular application(s) or function(s) in the electronic device, and/or to data stored or is accessible via the electronic device. The one or more access related parameters may be adaptively adjusted based on a plurality of control parameters. In this regard, the control parameters may comprise a data valuation parameter, an unwanted access probability parameter, and/or an improper access rejection parameter. The electronic device may dynamically determine or estimate values of one or more of the control parameters. The user related information may comprise information pertaining to, provided by, and/or obtained from the user. For example, the user related information comprises biometric data, such as when the security access function is based on, and/or incorporate biometric-based authentication—that is authenticating a person based on certain characteristics that may uniquely identify that person. In this regard, the characteristics used in uniquely identifying a person may be physical, mental, emotional or psychological. However, the disclosure is not limited to any particular type of characteristics. The biometric-based user authentication may comprise, for example, identification based on fingerprint, facial recognition, iris recognition, retinal scan, and/or voice. Biometric-based user authentication may also comprise use patterns, such as signature, scribble, and/or swipe pattern(s), and/or timing of keystrokes. For example, with facial recognition functions, the user related information may comprise facial related data (e.g., image of the face of the person attempting to access the device), and the security access function may be based on outcome of facial recognition based comparison(s) using the facial related data and previous facial related data. The security access functions, and control thereof, in accordance with the present disclosure need not be based on and/or incorporate biometric information and/or biometric based functions (e.g., for user authentication). In this regard, the disclosure is not limited to any particular type of user related information, and similar mechanisms may be used based on any user related information that may be used in identifying users and/or in determining when or if to allow access to particular users.

In an embodiment, locking and/or unlocking of the electronic device may be based on obtaining current biometric data associated with a user attempting to access the electronic device; and comparing the current biometric data with prior biometric data associated with an authorized user of the electronic device. The dynamic controlling may comprise adaptively adjusting one or more parameters utilized during the comparing of the current biometric data with the prior biometric data. In this regard, the one or more parameters may comprise at least one threshold for measuring sufficient similarity between the current biometric data with the prior biometric data.

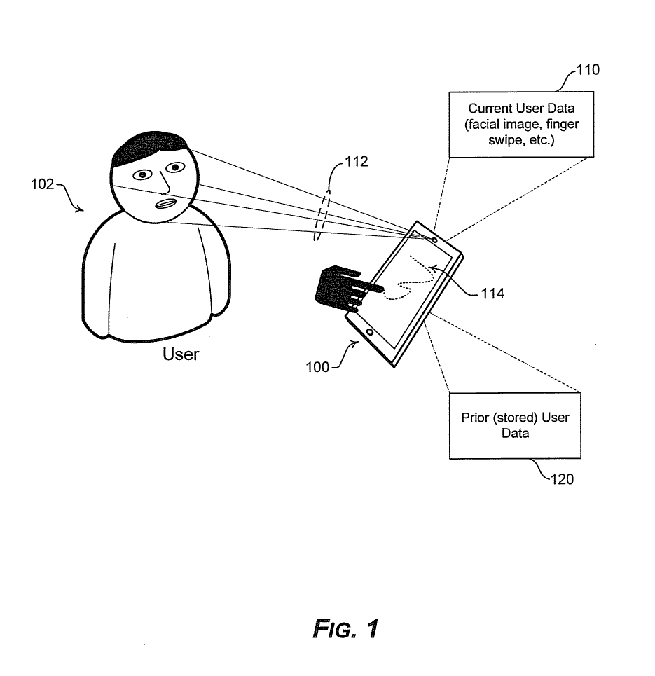

FIG. 1 is a block diagram illustrating a communication device 100 that may be locked and/or unlocked based on user-related data, in accordance with an embodiment of the disclosure.

The communication device 100 may comprise suitable logic, circuitry, interfaces, and/or code operable to communicate via wired and/or wireless connections, in accordance with one or more supported wireless and/or wired protocols or standards. Exemplary communication devices may comprise cellular phones, smartphones, tablets, laptop computers, desktop or personal computers, and/or servers. The disclosure, however, is not limited to any particular type of communication device. The communication device 100 may also incorporate additional components for generating and/or obtaining certain information. For example, the communication device 100 may comprise sensors for obtaining and/or generating data relating to, for example, the device location, environment, and the like. The communication device 100 may also comprise dedicated components enabling interactions with users, such as to obtain user input and/or to provide user output.

In operation, the communication device 100 may be utilized to perform wireless and/or wired communications. In this regard, the communication device 100 may be operable to transmit and/or receive signals, wirelessly or via wired connections, to facilitate sending and/or receiving of data from and/or to the communication device 100. During communication operations by the communication device 100, various wired and/or wireless technologies, protocols, and/or standards may be supported and/or utilized. For example, the communication device 100 may be used to communication data wirelessly via WiFi links, cellular (3G and/or 4G) links, and/or other similar wireless connections. In addition to performing communication operations, the communication device 100 may be operable to perform and/or support additional functions. For example, the communication device 100 may be operable and/or configured to incorporate secure access functions, which may be used to control access to and/or use of the communication device 100, and/or to application(s), function(s), and/or data accessible and/or utilized through the communication device 100. The communication device 100 may, for example, support use of locking/unlocking mechanisms for preventing or allowing access to the communication device 100 by users, such as user 102.

The communication device 100 may be locked or unlocked based on, for example, data pertaining to and/or provided by the user 102, which may enable reliably confirming identity of the user 102. For example, the communication device 100 may incorporate and/or utilize biometric-based user authentication mechanisms to determine when access is granted or denied, and/or when the device should be locked or unlocked. Biometric-based user authentication may comprise, for example, user identity confirmation based on fingerprints, facial recognition, iris recognition, retinal scan, and/or voice recognition. Biometric-based user authentication may also comprise user identity confirmation based on particular use and/or interaction patterns, such as signature, scribble, and/or swipe pattern(s), and/or timing of keystrokes. For example, locking/unlocking of the communication device 100 may be based on facial recognition and/or swipe patterns. In this regard, current user specific, data (110) pertaining to and/or provided by the user attempting to access the communication device 100 may be obtained or generated, for use in authenticating the user. For example, using facial recognition locking/unlocking mechanism may comprise capturing (112) an image of the face of the user attempting to access the communication device 100, for use in authenticating the user. In this regard, in some instances, use of facial recognition may not necessarily require comparing complete/full images. Rather, facial recognition related comparisons may be done using component analysis, which may focus on only particular characteristic(s) relating to the images, such as symmetry and/or tonal variation distribution. Similarly, use of a swipe pattern based locking/unlocking mechanism may comprise obtaining a swipe pattern (114) of the user attempting to access the communication device 100, for use in authenticating the user.

Once the current user data 110 have been obtained, the data may be compared with corresponding prior user data 120 to enable determining whether the user 102 is allowed access to the device 100. In this regard, prior user data 120 may be stored, and/or be maintained by the communication device 100. While ideally it would be desirable to capture or obtain current data that result in perfect match when compared with the prior data, such perfect matching may be unlikely or even impossible. For example, different images of user's face rarely if ever match perfectly, especially after a lapse of time. Similarly, with swipe patterns, in some instances users may not be able to perfectly repeat swipes previously configured for identity verification. Accordingly, in an exemplary aspect of the disclosure, a certain measure of varying tolerance may be incorporated into user related data based security functions. In other words, data comparisons performed during security functions may be configured as to result in success—thus resulting in granting access—when there is adequate rather than perfect match, such as when there exists certain dissimilarity between the current data and the prior data, but that dissimilarity is within preconfigured acceptable range. For example, with facial recognition, one or more thresholds may be used during matching comparison between current images and prior image, to specify an acceptable degree of dissimilarity in positive (adequate) match—i.e., allowing matching images that may not be perfect match.

Assigning different values to the matching thresholds may result in different outcomes of the matching determination, due to corresponding different ranges of tolerated variations in the data. Varying the values of the matching thresholds may also result in, and/or be associated with different types of errors or unwanted outcomes. For example, threshold values that may allow for higher mismatch tolerance—that is tolerating higher degree of dissimilarity during data comparisons—may result in unauthorized users being allowed access when they should be denied access. For instances, using low threshold in facial recognition based function may result in unintended users gaining access when their images are sufficiently close based on the applicable matching threshold. This may be referred to as “false acceptance.” On the other hand, threshold values that impose low mismatch tolerance—that is requiring high degree of similarity when comparing data—may result in deny access to or locking out someone who is an intended, authorized user. This may be referred to as “false rejection.” Accordingly, a secure access function that utilizes user related data comparisons, such as facial recognition based comparison, in locking/unlocking systems (e.g., the communication device 100) essentially makes a trade-off between such two kinds of errors, and when the threshold is set statically, and is not modifiable thereafter, such trade-off is static, decided in advance, and applies to all the users of the systems.

In various embodiments of the disclosure, secure access functions in communication devices, such as the communication device 100, may be dynamically and/or adaptively controlled. In this regard, such dynamic and/or adaptive control of secure access functions may comprise dynamically and/or adaptively setting or modifying parameters and/or criteria utilized in determining when to allow (or not) access to devices, such as the communication device 100. For example, with facial recognition-based secure access functions, matching thresholds that are used in determining when there is adequate match between different images (e.g., current facial image vs. prior facial images) may be adjusted and/or modified, to adjust mismatching tolerances when comparing the images (or acceptable tolerances for particular characteristics—e.g., during symmetry and/or tonal variation distribution based comparisons). In other words, the trade-off between errors that may occur in facial recognition based mechanisms—e.g., false rejections or false acceptance—may become user-specific and dynamic. In this regard, the communication device 100 may be configured to operate more securely, which may result in more false rejections and fewer false acceptances under certain conditions. For example, secure access functions in the communication device 100 may be adjusted to operate at higher security levels when it may be determined that there is a larger chance that someone other than intended user(s) may be attempting to access the device, and/or where more valuable data may be available, and thus may be exposed during unintended access. Conversely, when there is less need for security, the communication device 100 may be configured to be more permissive, which may result in less false rejections and larger probability of false acceptances.

The dynamic and/or adaptive controlling of the secure access functions may be based on monitoring and/or tracking of the communication device 100, its environment, operations thereof, applications and/or programs running or executed therein, and/or interactions between the communication device 100 and user(s) thereof. In this regard, dynamic and/or adaptive adjustments to the secure access functions in the communication device 100 may be triggered and/or caused by conditions or changes in or relating to the communication device 100 (e.g., its location), conditions or changes in its environment (e.g., temperature and/or lighting in the area around the communication device 100), type and/or state (e.g., running or not) of application(s) in the communication device 100, and/or parameters related to use of the device (e.g., duration since last use by an authorized user). In some instances, experimentation and/or prior use or history may be utilized in adjusting and/or modifying the secure access functions, and/or parameters or criteria used thereby. For example, the secure access functions may be adjusted in accordance with monitoring of user selections under similar conditions (location, time, use, etc.). The adaptive and/or dynamic control of secure access functions may be based on need to increase or decrease required security levels in the communication device 100. In this regard, the monitoring and/or tracking may enable determining when changes and/or conditions may require increasing (or allow for reducing) security of the communication device 100.

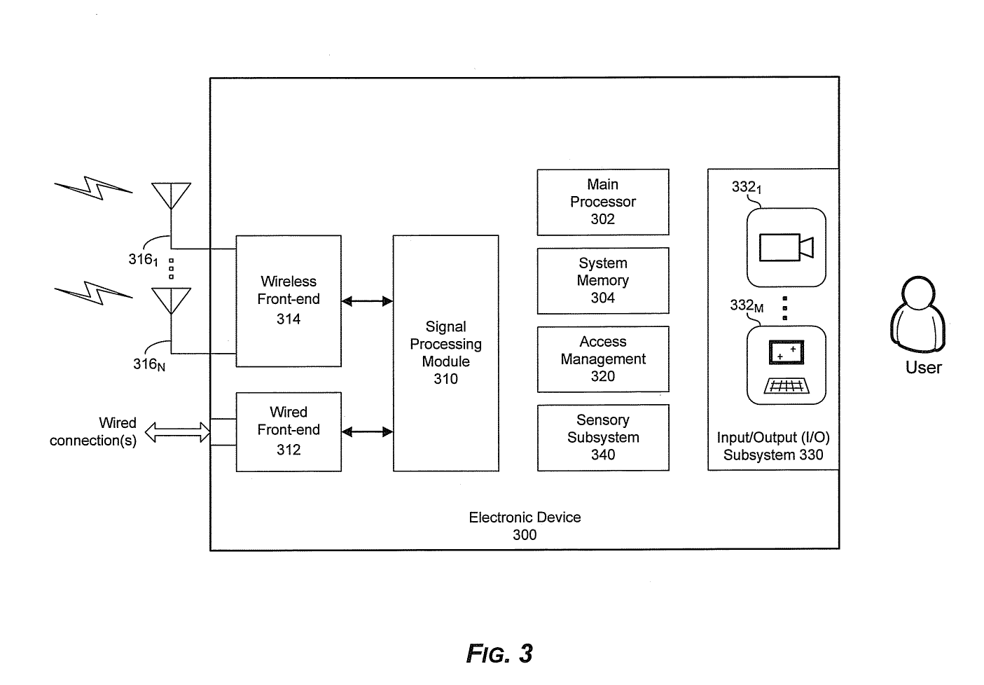

Various factors and/or criteria may be considered in determining the level of required security. For example, determining the required security level in the communication device 100, and the dynamic and/or adaptive controlling of the secure access functions based thereon, may be performed continually, based on determination or estimation, at any given point, of likelihood or probability of unauthorized access (break-in) attempts and/or cost of such unwanted access. In this regard, because the communication device 100 may be utilized to run and/or execute applications in which confidential or valuable information (e.g., personal information, passwords, etc.) may be generated, used, or communicated, the cost of unwanted access may be based on data that may be exposed at any given point as a result of such unwanted access. This is described in more detail with respect to, at least, FIG. 3.

While various embodiments of the disclosure are described with respect to communication devices and/or with respect to facial recognition based secure access functions, the disclosure need not be so limited. In this regard, similar mechanisms as described with respect to the embodiments of the disclosure described therein may be utilized with any secure access function that may be utilized to guard against unwanted access of any electronic device comprising components and/or functions necessary for practicing the disclosure, especially electronic devices having information that may be valuable.

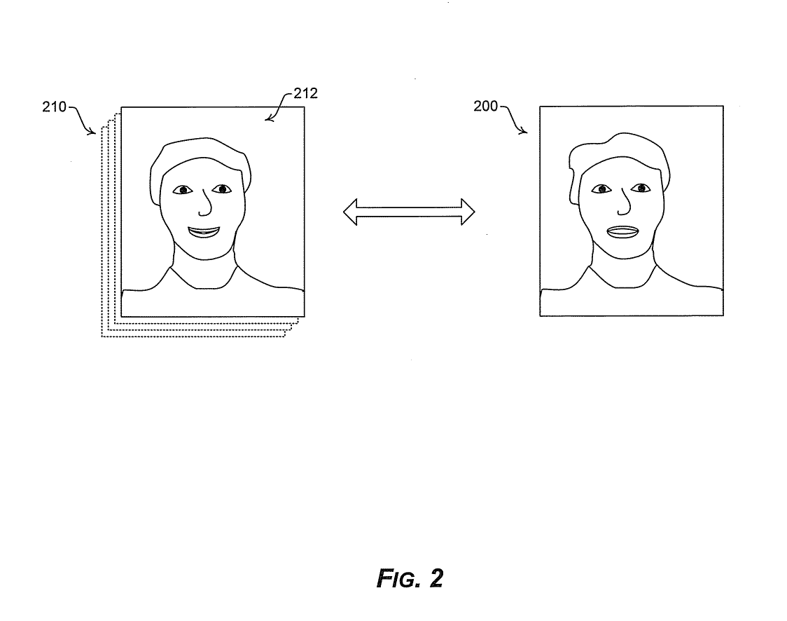

FIG. 2 is a block diagram illustrating use of dynamic facial recognition based secure access function, in accordance with an embodiment of the disclosure. Referring to FIG. 2, there is shown a current image 200 and a plurality of reference images 210.

The current image 200 may comprise an image, which is captured and/or obtained at present time of a user, for example a user attempting to access a particular system such as the communication device 100. In this regard, the current image 200 may comprise an image representing predominately the face region of the user, and as such may be utilized for facial recognition based secure access—e.g., to unlock the system, thus allowing access thereto.

The plurality of reference images 210 may comprises one or more images representing predominately the face region of a user. In this regard, the plurality of reference images 210 may comprise prior and/or existing images of the user that may be stored and/or maintained in a system, such the communication device 200. The plurality of reference images 210 may be utilized, for example, in user specific secure access functions. For example, the plurality of reference images 210 may enable authentication if a user is an authorized user by use of facial recognition based mechanism. In this regard, the current image 200 may be compared with the plurality of reference images to determine whether the user currently attempting to obtain access to the system is an authorized user by successfully matching the face image of the user with prior facial images represented by the plurality of reference images 210.

In operation, a facial recognition based secure access function may be utilized for controlling access to a device, such as the communication device 100. In this regard, determining whether to allow (or not) a particular user access to the device may be based on comparing an image of the user seeking access to the device with existing images of authorized users associated with the device. For example, when a particular user attempts to obtain access to the communication device 100, the current image 200 of that user may be obtained. In this regard, the current image 200 may be obtained directly via the communication device 100 (e.g., using built-in camera) or by use of separate, peripheral device (e.g., external camera connected via USB or other interface). The current image 200 may then be compared with the plurality of reference images 210, which may be maintained by the communication device 100. In this regard, the comparison may comprise identifying an image from the plurality of reference images 210 that may be the best match for the current image 200 (e.g., reference image 212). The current image 200 may then be compared with the best match image (reference image 212) to determine if the user shown in the current image 200 is the same user identified by the reference image 212. In this regard, various facial recognition algorithms and/or mechanisms may be utilized to compare the facial region in the current image 200 is the same user identified by the reference image 212.

Because perfect matches are typically unlikely, facial recognition based comparisons may allow for a certain degree of dissimilarity. Accordingly, applicable facial recognition algorithms and/or mechanisms utilized by the communication device 100 may incorporate and/or apply one or more similarity measures or thresholds which may allow for a certain degree of dissimilarity in comparing facial regions between different images, resulting in determination that a particular inspected face may be of an intended user of the device. For example, facial recognition based matching between the current image 200 and the reference image 212 may be deemed to be successful (thus allowing for access) despite changes or variation in the hair and/or the mouth regions (as shown in FIG. 2).

In various embodiments of the disclosure, similarity parameters (e.g., thresholds) may be adaptively and/or dynamically modified, thus resulting in corresponding dynamic and/or adaptive adjustments to secure access functions incorporating and/or utilizing user-specific mechanisms such as facial recognition. For example, adjusting facial recognition related similarity threshold(s), which may be utilized in determining whether a current image (e.g., current image 200) sufficiently matches an existing reference image (e.g., image 212), may change the outcome of the comparison, and as such the determination of whether the user seeking access to the communication device 100 is allowed access or not. In this regard, lowering the threshold (i.e., allowing for higher degree of dissimilarity) may, for example, result in positive matching between the user whose face is shown in the current image 200 with the intended, authorized user whose face is shown in the reference image 212; whereas increasing the threshold (i.e., requiring higher degree of similarity) may result in negative match, and thus denying the current user access to the device and/or use thereof.

FIG. 3 a block diagram illustrating an electronic device 300 that supports dynamic control of secure access functions, in accordance with an embodiment of the disclosure.

The electronic device 300 may comprise suitable logic, circuitry, interfaces, and/or code that may be operable to implement various aspects of the disclosure. In this regard, the electronic device 300 may comprise, for example, a communication device such as the communication device 100 of FIG. 1. The electronic device 300 need not be limited to any particular communication device, and may comprise any device or system that incorporates secure access function(s) based on comparing user related information with corresponding prior, existing information.

The electronic device 300 may comprise, for example, a main processor 302, a system memory 304, a signal processing module 310, a wired front-end (FE) 312, a wireless front-end (FE) 314, a plurality of antennas 316_{A}-316_{N}, an access management module 320, an input/output (I/O) subsystem 330, and a sensory subsystem 340.

The main processor 302 may comprise suitable logic, circuitry, interfaces, and/or code that may be operable to process data, and/or control and/or manage operations of the electronic device 300, and/or tasks and/or applications performed therein. In this regard, the main processor 302 may be operable to configure and/or control operations of various components and/or subsystems of the electronic device 300, by utilizing, for example, one or more control signals. The main processor 302 may enable execution of applications, programs and/or code, which may be stored in the system memory 204, for example.

The system memory 304 may comprise suitable logic, circuitry, interfaces, and/or code that may enable permanent and/or non-permanent storage, buffering, and/or fetching of data, code and/or other information, which may be used, consumed, and/or processed. In this regard, the system memory 304 may comprise different memory technologies, including, for example, read-only memory (ROM), random access memory (RAM), Flash memory, solid-state drive (SSD), and/or field-programmable gate array (FPGA). The system memory 304 may store, for example, configuration data, which may comprise parameters and/or code, comprising software and/or firmware.

The signal processing module 310 may comprise suitable logic, circuitry, interfaces, and/or code operable to process signals transmitted and/or received by the electronic device 300, in accordance with one or more wired or wireless protocols supported by the electronic device 300. The signal processing module 310 may be operable to perform such signal processing operation as filtering, amplification, up-conversion/down-conversion of baseband signals, analog-to-digital conversion and/or digital-to-analog conversion, encoding/decoding, encryption/decryption, and/or modulation/demodulation. The signal processing module 310, along with the wired FE 312 and the wireless FE 314 may collectively constituted a shared RF subsystem that is commonly utilized by other components of the electronic device 300 for communicating data to and/or from the electronic device 300.

The wired FE 312 may comprise suitable logic, circuitry, interfaces, and/or code that may be operable to perform wired based transmission and/or reception, such as over a plurality of supported physical wired media. The wired FE 312 may enable communications of RF signals via the plurality of wired connectors, within certain bandwidths and/or in accordance with one or more wired protocols (e.g. Ethernet) supported by the electronic device 300.

The wireless FE 314 may comprise suitable logic, circuitry, interfaces, and/or code that may be operable to perform wireless transmission and/or reception, such as over a plurality of supported RF bands and/or wireless interfaces. The wireless FE 314 may enable, for example, performing wireless communications of RF signals via the one or more of the plurality of antennas 316_{A}-316_{N}. Each of the plurality of antennas 316_{A}-316_{N} may comprise suitable logic, circuitry, interfaces, and/or code that may enable reception and/or transmission of wireless signals within certain bandwidths and/or based on certain protocols. For example, one or more of the plurality of antennas 316_{A}-316_{N} may enable reception and/or transmission of signals communicated over different channels within 2.4 GHz band (e.g., during WiFi communication) and/or within supported cellular bands (e.g., 3G or 4G based bands).

The access management module 320 may comprise suitable logic, circuitry, interfaces, and/or code for managing access operations in the electronic device 300. The access management module 320 may be operable to perform user authentication in the electronic device 300, substantially as described with respect to FIGS. 1 and 2, for example. In this regard, the access management module 320 may be configured to support user specific secure access functions, such as facial recognition or swipe based security function, and/or may enable dynamically and/or adaptively controlling these secure access functions. The user authentication related operations may be directed at authenticating users associated with the electronic device 300 and/or various actions by the users, such as when attempting to unlock the electronic device 300. The access management module 320 may be operable to obtain user related information pertinent to authentication of users using the I/O subsystem 330, and/or to obtain sensory related information, which may be utilized in controlling and/or modifying the secure access functions, from the sensory subsystem 340.

The input/output (I/O) subsystem 330 may comprise suitable logic, circuitry, interfaces, and/or code for enabling inputting and/or outputting data into and/or from the electronic device 300. In this regard, the I/O subsystem 330 may support various types of inputs and/or outputs, including video, audio, and/or text. I/O devices and/or components, external or internal, may be utilized for inputting and/or outputting data during operations of the I/O subsystem 330. Exemplary I/O devices may comprise displays, mice, keyboards, touchscreens, and the like.

The I/O subsystem 330 may enable user interactions with the electronic device 300, enabling obtaining input from user(s) and/or to providing output to the user(s). In this regard, the I/O subsystem 330 may comprise a plurality of user I/O modules 332₁-332_{M}, for inputting and/or outputting data during user interactions. In this regard, each of the plurality of user I/O modules 332₁-332_{M} may comprise suitable logic, circuitry, interfaces, and/or code for capturing, obtaining, and/or generating information in accordance with particular type of user interactions available and/or supported by the electronic device 300. Exemplary user related information may comprise visual data, such as images, or retina (or iris) scans, associated with the user, which may be obtained via a camera/display (e.g., module 332₁); and/or user's tactile and/or textual input/output, which may be obtained using touchscreen and/or keypad (e.g., module 332_{M}). In an embodiment of the disclosure, the I/O subsystem 330 may be operable to capturing, obtaining, and/or generating information associated with a particular user, including biometric information for example, which may be utilized in authentication users attempting to access and/or use the electronic device 300.

The sensory subsystem 340 may comprise suitable logic, circuitry, interfaces, and/or code for obtaining and/or generating sensory information, which may relate to the electronic device 300, and/or its environment. For example, the sensory subsystem 340 may comprise positional or locational sensors (e.g., GPS or other GNSS based sensors), temperature and/or humidity sensors, light sensors, and/or motion related sensors (e.g., accelerometer, gyroscope, pedometers, and/or altimeters). In various embodiments of the disclosure, the sensory information (e.g., location, motion, and/or environment) obtained and/or generated via the sensory subsystem 340 may be used in controlling and/or adjusting secure access functions in the electronic device 300.

In operation, the electronic device 300 may be utilized to perform various operations, and/or run or execute various applications, such as in accordance with user instructions. In some instances, the operations of the electronic device 300 may require communication of data to and/or from the electronic device 300. For example, a banking application may require transmission of requests to obtain information regarding funds in particular accounts, and reception of the requested information thereafter. To that end, the electronic device 300 may be operable to perform wired and/or wireless communication, in accordance with one or more interfaces and/or protocols supported thereby. In this regard, the electronic device 300 may perform transmission and/or reception of signals over supported wired and/or wireless interfaces, using the wired FE 312 and/or the wireless FE 314, which is utilized in conjunction with the antennas 316₁-316_{N}, and to perform necessary signal processing operations to facilitate such transmission/reception, using the signal processing module 310. The signals transmitted and/or received by the electronic device 300 may carry data pertaining to applications running in the electronic device 300.

The electronic device 300 may incorporate and/or support, via the access management module 320, secure access functions, which may be used to control access to and/or use of the electronic device 300. In this regard, the secure access functions implemented via the access management module 320 may enable granting (or denying) access, to the electronic device 300 and/or to applications, data, and/or functions available in or through it, and/or locking or unlocking the electronic device 300. In some instances, the outcome of the secure access functions may be based on, for example, data pertaining to and/or provided by a user attempting to access and/or use the electronic device 300. The secure access functions of the electronic device 300 may be based on, for example biometric-based user authentication mechanisms to determine when access is granted or denied, and/or when the device should be locked or unlocked. Biometric-based user authentication may comprise, for example, user identity confirmation based on fingerprints, facial recognition, iris recognition, retinal scan, and/or voice recognition. Biometric-based user authentication may also comprise user identity confirmation based on particular use and/or interaction patterns, such as signature, scribble, and/or swipe pattern(s), and/or timing of keystrokes. In this regard, such biometric-based mechanisms comprise using data obtained from and/or provided by the users, such as via the I/O subsystem 330 and/or the sensory subsystem 340. For example, facial recognition based access functions may comprise obtaining, using the I/O module 332₁, current image of a user seeking access to the electronic device, and comparing it to a plurality of reference images, stored in the system memory 304 for example, to determine whether to allow (or not) access, substantially as described with respect to FIG. 2. Another secure access function may incorporate use of swipe pattern matching, based on comparison of current swipe patterns provided via, for example, a touchscreen (e.g., I/O module 332_{M}), which may be compared against a bank of prior swipe patterns maintained in the system memory 304 for determination of whether a positive (sufficient) match is found.

In various embodiments of the disclosure, the access management module 320 may be operable to dynamically and/or adaptively control secure access functions in the electronic device 300. In this regard, dynamic and/or adaptive controlling of secure access functions may be based on determination of the need to increase or decrease required security in the electronic device 300. Determining when to increase or decrease security level in the electronic device 300 may be based on, for example, monitoring and/or tracking of the electronic device 300, its operations thereof, applications and/or programs running or executed therein, and/or interactions between the electronic device 300 and user(s) thereof. Adjusting and/or configuring the security level of the electronic device 300 may also be based on monitoring and/or tracking of the location and/or environment of the electronic device 300, such as using sensory information obtained via the sensory subsystem 340. For example, determining the required security level in the electronic device 300, and the dynamic and/or adaptive controlling of the secure access functions based thereon, may be performed based on an evaluation of a likelihood of unauthorized access, a cost of unauthorized access to the electronic device 300, and/or a cost (or inconvenience) of improper rejection of access—i.e., denying access to an intended user.

The cost of unauthorized access may be expressed as a valuation (V) parameter, which may represent the value of data that need be kept private and protected, which might be exposed as result of unauthorized access. The V parameters may also represent estimation of anticipated cost of unauthorized access. For example, the V parameter may represent the estimated financial cost (or loss) that may result if a malicious, unauthorized access occurred. Therefore, the bigger the V parameter is, the more security level may be required in the electronic device 300. In this regard, because the electronic device 300 may be utilized to run and/or execute various applications (e.g., banking applications) which may require generation, use and/or communication of confidential or valuable information (e.g., personal information, passwords, etc.), the valuation (V) parameter may be proportional to the value of private, confidential data that may be exposed at any given point.

The value of the V parameter may be determined and/or estimated heuristically. The value of the V parameter may increase, for example, when more applications are available, open, and/or running in the electronic device 300. In this regard, increases in the V parameter may depend on the type of application—e.g., banking applications would cause bigger increase in the value of the V parameter compared to call applications, since data associated with banking application may typically be more confidential and valuable to the user. The V parameter estimation may also depend on which applications were installed, even if they were not running. For example, applications that may incorporate their own security measures (e.g., require password login) may affect the V parameter less than applications lacking such separate security measures even though they may require, allow, and/or grant access to private, confidential information. A web browser application's value of the V parameter, for example, may depend on how many passwords it was set to remember. The V parameter may also depend on the type and amount of data in the electronic device 300. For example, certain types of data (e.g., music) may typically not be private, personal data, and as such it may not contribute much to the V parameter. In some embodiment, the V parameter may comprise a sum of terms, where each term may correspond to an application in a particular condition or an item of data on the electronic device. In this regard, the terms used in calculating or determining the V parameter may be weighed—that is terms may have varying multipliers, such that effect and/or impact of certain terms, and/or any changes thereto, may factor more heavily into the determination of the V parameters. These values can be stored in a look-up table, for example, or reported by the applications themselves.

The likelihood of unauthorized access may be expressed as a probability (P) parameter, which may represent an estimated probability of break-in attempts. Therefore, the bigger the P parameter is, the higher security level may be required in the electronic device 300. The value of the P parameter may be determined and/or estimated based on various factors, data, and/or criteria. The P parameter may be calculated and/or adjusted based on, for example, sensory data obtained or captured by the electronic device 300. The P parameter may be calculated and/or adjusted based on, for example, timing data. For example, the P parameter may be increased based on elapsed time since last use by an intended user—i.e., if the electronic device 300 had just been used a few seconds ago, it is likely that the user is just returning to continue doing what was just being done, and thus the P parameter would be small; and as the interval since the last use grows, the P parameter increases. The P parameter may also be calculated and/or adjusted based on current time. In this regard, break-ins may be known to be more common at certain times of the day, and thus the P parameter may be changed dynamically based on detected time of day, to reflect varying odds of the electronic device 300 being stolen and/or being subjected to unauthorized access attempts.

The P parameter may also be calculated and/or adjusted based on location related data. Break-ins may be more likely, for example, in certain geographic locations. For example, a location known to be associated with the user (e.g., intended user's workplace or home) and/or locations where the electronic device has been in many times before would likely be associated with authorized user and/or authorized use of the electronic device, and therefore for translate to smaller values for the P parameter. On the other hand, when the electronic device 300 is away from intended user's normal locations, the P parameter may be larger. Known characteristics of the locations may also be used in setting the P parameter. For example, locations that may be known to be associated with higher likelihood of crime (e.g., based on available crime databases) may translate to higher values for the P parameters. The P parameter may also be calculated and/or adjusted based on environmental data. For example, in instances where the electronic device 300 may be operable to obtain or generate temperature and light sensory data, such data may be utilized in determining or estimating the P parameter. Such data may enable determining, for example, whether the electronic device 300 had been kept safely in a pocket, thus resulting in assigning the P parameter a lower value. Also, because devices may be lost more often in certain conditions, sensory data (of any types) may be utilized in determining when such conditions occur. For example, location and/or environmental data (e.g., hot and bright location), which may be obtained via the sensory subsystem 330, may indicate that the electronic device 300 is at a beach, a location where use of the electronic device 300 is less likely and/or where devices are frequently left unprotected, thus mandating assigning higher value to the P parameter. Experiment and/or prior use (or history thereof) may be utilized in determining the combinations of conditions where the P parameter may be assigned large values.

The P parameter may also be calculated and/or adjusted based on sensory data that show unique characteristics of intended user's handling or use of the electronic device 300. For example, certain sensory data, such as orientation of the electronic device 300—e.g., relative to gravity, as read from the electronic device 300 accelerometers for example—associated with particular uses, such as when taking pictures, may be unique to an intended user because each user tends to hold the electronic device 300 at a characteristic angle, and an unauthorized attempted user will probably choose a measurably different angle. The P parameter may also be set or adjust based on previous break-in attempts. For example, the electronic device 300 had been activated, aimed at a face, and the facial recognition algorithm determined that the face is not the face of the authorized user, the P parameter value for subsequent access attempt may be set to higher values.

The cost or inconvenience of improper rejection of access—i.e., when an intended user is erroneously denied access or locked out of the electronic device 300—may be expressed as a rejection (R) parameter. In this regard, the R parameter may correspond to the inconvenience and/or cost that may result if the authorized user is incorrectly rejected—that is the higher the value of R parameter is the less improper rejection of access would be accepted (and as such, the less secure the electronic device would be). The R parameter may be set based on user input (e.g., selection) and/or from experimentation. In some embodiments, the R parameters may be adaptively adjusted, such as based on tracked use (or patterns thereof) associated with particular user.

Once the V parameter, P parameter, and the R parameters are computed and/or adjusted, the access management module 320 may utilize them to adjust similarity thresholds that may be used during comparisons between current user related (e.g., current image) with prior, existing user related data (e.g., bank of reference images) when determining whether there may be sufficient match to allow access. For example, the threshold adjustments may be determined based on the following expression (e.g., by determining values of the “threshold” parameters that would result in the minimum outcome from the expression):

P*V*FalseAccept(threshold)+R*FalseReject(threshold) (1)

where FalseAccept is the probability, expressed as function of the “threshold” parameter, of improperly allowing an unauthorized person to access the electronic device 300, FalseReject is the probability, expressed as function of the “threshold” parameter, of falsely rejecting an authorized user, and ‘threshold’ is the parameters against which similarity measures may be compared when determining whether there is sufficient match or not. The “threshold” used in the previous expression may be selected by, for example, searching for the threshold value that may minimize the overall cost. For example, the threshold applied to the FalseAccept( ) and FalseReject( ) functions may be determined by applying the previous expression for all possible values of “threshold” and then taking the threshold that may yield the minimum value of the expression.

The threshold used in secure access may be determined, using a linear shift for example, based on a default value:

threshold=threshold₀±(α*P*V/R) (2)

where threshold₀ may correspond to an applicable default threshold value—that is the threshold applicable to matching comparisons in absence of any security related adjustments (e.g., when P and V are set to 0)—and α is an adjustment weight applicable to the security parameters (p and V) in accordance with desired security level and/or policy. In other words, the higher the value of α is, the higher the threshold (and this matching similarity) required for allowed access. Parameters α and threshold₀ may be determined experimentally. The current expression (2) may correspond to a practical approximation of the previous expression (1), and may be especially useful—for determining the “threshold” parameter—when the FalseAccept( ) and FalseReject( ) functions may not be well known. Alternatively, applying and/or using the present expression (2) be more convenient in certain conditions—e.g., in a device that has limited power, memory, and/or or CPU resources or capacity, to minimize the processing and/or resources required or used for the threshold determination.

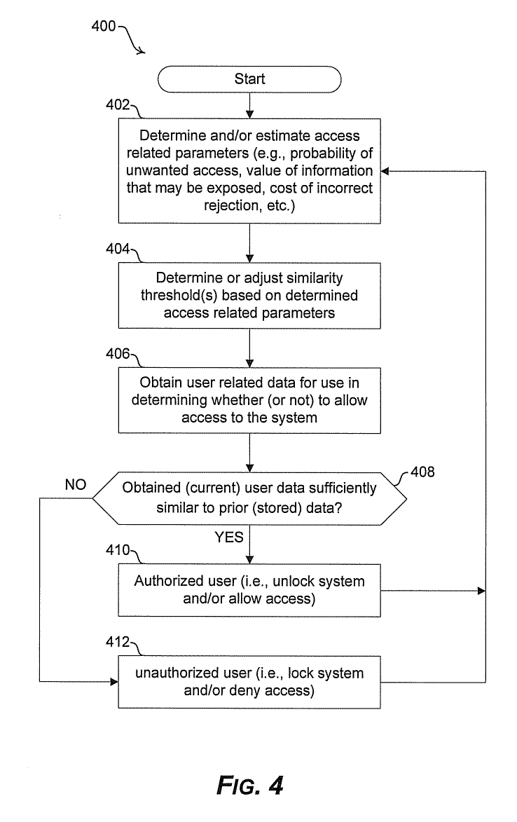

FIG. 4 is a flow chart that illustrates steps for dynamically controlled secure access, in accordance with an embodiment of the disclosure. Referring to FIG. 4, there is shown a flow chart 400 comprising a plurality of steps for performing dynamic and/or adaptive user specific secure access operations in a device, such as electronic device 200. The process described in flow chart 400 may be performed periodically and/or on a per-need basis, such as whenever a user attempts to access (e.g., unlock) a device, such as the electronic device 200.

In step 402, access related parameters may be determined and/or estimated. In this regard, access related parameters may comprise such parameters as probability of unwanted access (P), value of information that may be exposed (V), and/or cost of incorrect rejection (R). In step 404, parameters and/or criteria, such as similarity threshold(s), which may be utilized when performing matching evaluation during user validation operations, may be determined and/or adjusted based on access related parameters, as determined or estimated in step 402. In step 406, user related data, which may be utilized for use in determining—e.g., by use of matching comparison—of whether (or not) to allow access, may be obtained. This may comprise, for example, obtaining current facial images or swipe patterns.

In step 408, the obtained current user related data may be compared with prior, existing corresponding related data, to determine if it is sufficiently similar. In this regard, the determination may account for tolerated degree of variation, which may be factored into the comparison. The tolerated dissimilarity may be determined based on the similarity thresholds as determined and/or adjusted in step 404. In instances where current data is deemed to be sufficiently similar, the process may proceed to step 410, where the user may be deemed to be an authorized, intended user—thus may be allowed to unlock the system and/or is allowed access thereto. Returning to step 408, in instances where current data is deemed to not be sufficiently similar, the process may proceed to step 412, where the user may be deemed to be an unauthorized, non-intended user—thus would not be allowed to unlock the system and/or would not be allowed access to the system.

Other embodiments of the disclosure may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the steps as described herein for dynamic control of device unlocking security level.

Accordingly, the present disclosure may be realized in hardware, software, or a combination of hardware and software. The present disclosure may be realized in a centralized fashion in at least one computer system, or in a distributed fashion where different elements are spread across several interconnected computer systems. Any kind of computer system or other system adapted for carrying out the methods described herein is suited. A typical combination of hardware and software may be a general-purpose computer system with a computer program that, when being loaded and executed, controls the computer system such that it carries out the methods described herein.

The present disclosure may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present disclosure has been described with reference to certain embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments falling within the scope of the appended claims.

1. A method for controlling access to operation of an electronic device, comprising:
determining information relating to a user of said electronic device;
receiving an unwanted access probability, wherein the unwanted access probability is a likelihood of one or more unwanted access attempts; and
adaptively adjusting one or more parameters utilized in determining when access to said electronic device is granted or denied, said adjusting based on the unwanted access probability, said determining of when access to said electronic device is granted or denied is based on comparing said information with corresponding previous information.

2. The method of claim 1, wherein said information relating to said user comprises biometric information.

3. The method of claim 2, comprising comparing said biometric information with previous corresponding biometric data to determine when said biometric information adequately matches said previous corresponding biometric data.

4. The method of claim 1, wherein said one or more parameters comprise a plurality of thresholds used in determining when variation between said information and said corresponding previous information is acceptable.

5. (canceled)

6. (canceled)

7. (canceled)

8. (canceled)

9. (canceled)

10. A system, comprising:
an electronic device that enables controlling access to operation of said electronic device; said electronic device being operable to:
determine information relating to a user of said electronic device;
receive an unwanted access probability, wherein the unwanted access probability is a likelihood of one or more unwanted access attempts; and
adaptively adjust one or more parameters utilized in determining when access to said electronic device is granted or denied, said adjusting based on the unwanted access probability, and said determining of when access to said electronic device is granted or denied is based on comparing said information with corresponding previous information.

11. The system of claim 10, wherein said information relating to said user comprises biometric information.

12. The system of claim 11, wherein the electronic device is operable to compare said biometric information with previous corresponding biometric data to determine when said biometric information adequately matches said previous corresponding biometric data.

13. The system of claim 10, wherein said one or more parameters comprise a plurality of thresholds used in determining when variation between said information and said corresponding previous information is acceptable.

14. (canceled)

15. (canceled)

16. (canceled)

17. (canceled)

18. (canceled)

19. A method, comprising:
controlling locking and/or unlocking of a communication device; wherein:
said locking and/or unlocking is based on:
obtaining current biometric data associated with a user attempting to access said communication device; and
comparing said current biometric data with prior biometric data associated with an authorized user of said communication device; and
adaptively adjusting one or more parameters utilized during said comparing of said current biometric data with said prior biometric data, based on an unwanted access probability wherein the unwanted access probability is a likelihood of one or more unwanted access attempts.

20. The method of claim 19, wherein said one or more parameters comprise at least one threshold for measuring sufficient similarity between said current biometric data with said prior biometric data.

21. The method of claim 19, comprising storing at least a portion of said prior biometric data by said communication device.

22. The method of claim 19, comprising collecting at least a portion of said prior biometric data by said communication device.

23. A non-transitory machine-readable storage having stored thereon, a computer program having at least one code section for controlling access to operation of an electronic device, the at least one code section being executable by a machine for causing the machine to perform steps, comprising:
determining information relating to a user of said electronic device;
receiving an unwanted access probability, wherein the unwanted access probability is a likelihood of one or more unwanted access attempts; and
adaptively adjusting one or more parameters utilized in determining when access to said electronic device is granted or denied, said adjusting based on the unwanted access probability, said determining of when access to said electronic device is granted or denied is based on comparing said information with corresponding previous information.

24. The non-transitory machine-readable storage of claim 23, wherein said information relating to said user comprises biometric information.

25. The non-transitory machine-readable storage of claim 24, the at least one code section comprising code for comparing said biometric information with previous corresponding biometric data to determine when said biometric information adequately matches said previous corresponding biometric data.

26. The non-transitory machine-readable storage of claim 23, wherein said one or more parameters comprise a plurality of thresholds used in determining when variation between said information and said corresponding previous information is acceptable.

27. (canceled)

28. (canceled)

29. (canceled)

30. (canceled)

31. (canceled)
